(19) United States
(12) Patent Application Publication
(10) Pub. No.: US 2015/0046358 A1
(43) Pub. Date: Feb. 12, 2015

(54) IMPORTING TESTED OBJECTS INTO BENEFITS PROGRAMS DEPLOYED ON PRODUCTION SYSTEMS

(71) Applicant: Oracle International Corporation, Redwood Shores, CA (US)

(72) Inventors: Nagaraj Mohan Hunur, Hyderabad (IN); Naresh Boddapati, Hyderabad (IN); Abhishek Maurya, Hyderabad (IN); Sravani Seggam, Hyderabad (IN); Praveen Kolla, Hyderabad (IN); Gautam Katada, Hyderabad (IN)

(73) Assignee: Oracle International Corporation, Redwood Shores, CA (US)

(21) Appl. No.: 13/961,904

(22) Filed: Aug. 8, 2013

(51) Int. Cl. G06Q 10/10

(52) U.S. Cl. CPC G06Q 10/1057
USPC 705/322

(57) ABSTRACT

An aspect of the present disclosure facilitates importing of tested objects into benefit programs deployed on a production system. In one embodiment, a digital processing system receives a first data representing tested objects to be imported to the production system and a second data indicating whether or not to reuse any of already deployed objects in the production system. The digital processing system imports the tested objects into the production system based on the details of the first data, second data and the already deployed objects in the production system.

### BACKGROUND OF THE DISCLOSURE

1. Technical Field

The present disclosure relates to application servers used for human capital management, and more specifically to importing tested objects into benefits programs deployed on production systems for such human capital management.

2. Related Art

Benefits programs refer to a collection of various benefit options provided to the employees of an enterprise. Each benefit option generally refers to a tangible benefit in one of dental, medical, retirement and life insurance, etc.

Objects are the basis for modeling the details of various benefit options present in benefit programs. Each object is an instance of an object type, with types being defined to capture different types of information related to the benefits. The object types are commonly organized in a hierarchy to reflect that the objects/object types at the lower levels are choices available within the objects/object types at a higher level.

For example, an object type (“plan”) at one level may provide the model for specifying various plans (e.g., Aetna global health) made available to employees by different benefits providers. An object type (“option”) at an immediate lower level may provide the model for specifying the various choices (e.g., employee only, employee plus family, etc.) within each plan. The relationship of objects at immediate levels is specified by references such that the objects and the references together define a benefits program available in an enterprise.

Benefits programs thus defined are often deployed on production systems in an enterprise, such that employees of the enterprise can thereafter avail of desired and eligible benefit options by interacting with such production systems.

There is often a need to import objects into benefits programs deployed on production systems. The importation is typically performed to add new benefits programs, benefits providers/plans, benefits options, etc., as is well known in the relevant arts.

Such objects to be imported are generally tested on a separate (testing) system prior to importing into the production system. Testing entails performing any desired configurations of the objects and confirming the overall operation consistent with the policies of the enterprise. Once testing is performed to a desired satisfaction level, the tested objects are imported into the production system.

It is generally desirable that importing of tested objects into benefits programs deployed on production systems be simplified.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which the importing of tested objects into benefit programs deployed on production systems is simplified in one embodiment.

FIG. 3A depicts a structure of a benefits program in one embodiment.

FIG. 3B depicts portions of data representing a benefits program (in particular the benefits program shown in FIG. 3A) in one embodiment.

FIG. 4A-4D together illustrates the manner in which an administrator is facilitated to import desired tested objects into benefit program deployed on a production system in one embodiment.

FIG. 4E illustrates the manner in which an administrator is facilitated to validate the import of tested objected into a production system in one embodiment.

FIGS. 5A-5B illustrates the state of a production system before and after importing of tested objects into benefits programs deployed on the production system in one embodiment.

FIG. 6 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates importing of tested objects into benefit programs deployed on a production system. In one embodiment, a digital processing system receives a first data representing tested objects to be imported to the production system and a second data indicating whether or not to reuse any of already deployed objects in the production system. In response, the digital processing system first determines whether a tested object is contained in the deployed objects.

If the tested object is determined to be contained in the deployed objects and if the second data indicates the reuse of deployed objects, the digital processing system determines any references to the tested object by examining the first data and then adds the determined references to a deployed object corresponding to the tested object. In other words, the deployed object is reused instead of adding the tested object to the production system.

If the tested object is determined to be contained in the deployed objects and if the second data indicates not to reuse deployed objects, the digital processing system adds the tested object with a new identifier (different from the original identifier in the first data). If the tested object is determined as not being contained in the deployed objects, the digital processing system adds the tested object with the original identifier to the production system.

According to another aspect of the present disclosure, the digital processing system displays for each object type, a corresponding first count of tested objects contained in the first data, and a corresponding second count of tested objects that have been added to the production system, with any reused deployed objects not being included in the second count.

According to one more aspect of the present disclosure, the digital processing system displays, for each object type, a first list of identifiers of tested objects of the object type contained in the first data, and a second list of identifiers of the tested objects of the same object type which have been added to the production system, with the second list including the original identifier or the new identifier for each object added to the production system, but does not include the identifier of the reused deployed objects.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

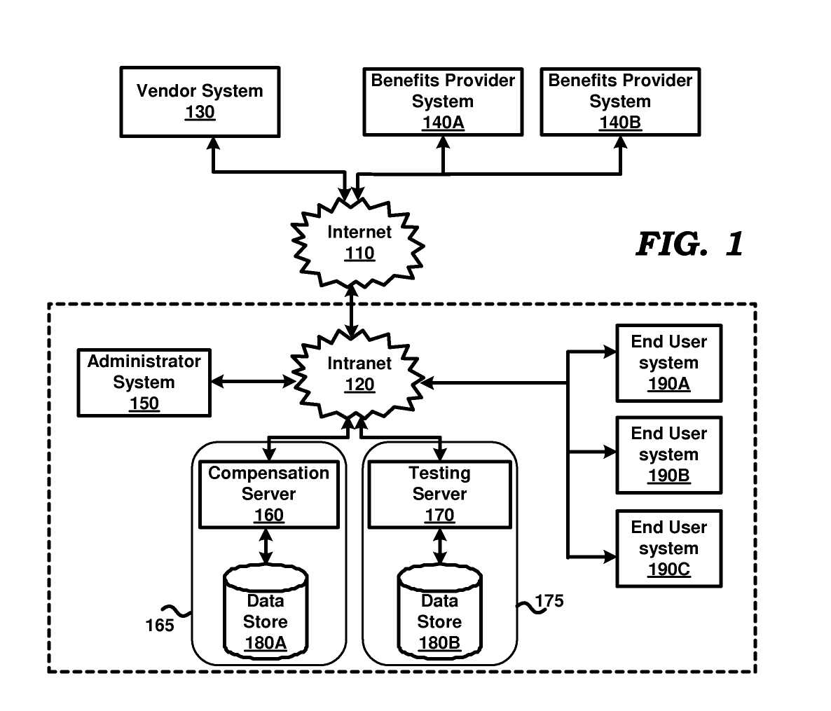

FIG. 1 is a block diagram illustrating an example environment (computing system) in which several aspects of the present disclosure can be implemented. The block diagram is shown containing Internet 110, intranet 120, vendor system 130, benefits provider systems 140A-140B, administrator system 150, compensation server 160, testing server 170, data store 180A-180B and end user systems 190A-190C.

Merely for illustration, only representative number/type of systems is shown in FIG. 1. Many environments often contain many more systems, both in number and type, depending on the purpose for which the environment is designed. Each system/device of FIG. 1 is described below in further detail.

Intranet 120 represents a network providing connectivity between administrator system 150, compensation server 160, testing server 170 and end user systems 190A-190C, all provided within an enterprise (as shown within the dotted boundary). Internet 110 extends the connectivity of these (and other systems of the enterprise) with external systems such as vendor system 130 and benefits provider systems 140A-140B. Each of intranet 120 and Internet 110 may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by Internet 110 and intranet 120. When the packet contains content such as port numbers, which specifies the destination application, the packet may be said to be directed to such application as well. The destination system may be required to keep the corresponding port numbers available/open, and process the packets with the corresponding destination ports. Internet 110 and intranet 120 may be implemented using any combination of wire-based or wireless mediums.

Vendor system 130 represents a system that facilitates one or more vendors of enterprise software to provide their software to various customer organizations (such as the enterprise noted above). The software may be provided to the customer organizations by way of downloading on Internet 110 or by mediums such as optical disks, tape drives, etc. (for example, in response to placing an order using vendor system 130). An example of enterprise software is benefits management software (for managing the benefits provided to the employees of an enterprise/organization) such as Oracle Human Capital Management (HCM), component of the Oracle Fusion Suite, both provided by the vendor Oracle Corporation, the Applicant of the present application. Other examples include the Benefits solutions from SAP Corporation, Workday software available from Workday Corporation, etc.

Each of benefits provider systems 140A-140B represents a provider or third party administrator organizations such as Aetna, HMO (health maintenance organization), etc., that provide various benefits to individual employees of a contracting organization (for example, the enterprise shown in the dotted boundary). The details of each benefit may be made available electronically by benefits provider systems 140A-140B to users (employees, administrators, etc.) of the enterprise via Internet 110. The enterprise shown in the dotted boundary may then decide upon the eligibility, duration, the tangible part of benefits, cost incurred by the employer (enterprise) and employees, etc.

It may be appreciated that the same benefits management software is provided (using vendor system 130) to several customer organizations, though only a single organization (the enterprise indicated by the dotted boundary) is shown in FIG. 1. Each of the customer organizations (after downloading or receiving the software from vendor system 130) may use the software as suited in their environment and accordingly customize the software to meet the organization's specific requirements prior to deployment in the enterprise. Such customization typically entails setting up the specific benefits programs, benefits options, and benefits providers (i.e., the objects and object types) offered to employees of the enterprise.

Each of data stores 180A-180B represents a non-volatile (persistent) storage facilitating storage and retrieval of a collection of data by applications executing in compensation server 160 and testing server 170 respectively. For example, each of data stores 180A and 180B may maintain details (in the form of objects and object types) of the benefits programs offered to the employees of the enterprise. Data store 180A may also store the details of specific benefits subscribed by each employee of the customer organization.

Each data store (180A-180B) may be implemented as a database server using relational database technologies and accordingly provide storage and retrieval of data using structured queries such as SQL (Structured Query Language). As is well known, database servers store data according to a relational model in the form of tables containing rows and columns, with the SQL queries facilitating the retrieval of data according to such a relational model. Alternatively, each data store may be implemented as a file server providing storage and retrieval of data in the form of files organized as one or more directories, as is well known in the relevant arts.

Each of end user systems 190A-190C represents a system such as a personal computer, workstation, mobile device, tablets, etc., used by users/employees of the enterprise/customer organization to generate server requests directed to applications executing in server systems such as compensation server 160 or testing server 170. The server requests may be generated using appropriate user interfaces (e.g., web pages provided by the enterprise application).

Thus, an employee of the enterprise requests an application for performing desired tasks and receives corresponding responses containing the results of performance of the requested tasks. Examples of such tasks include but are not limited to, providing the details of benefits programs offered by the enterprise, the various benefits options constituting each program, the details of the benefits options eligible for a user/employee, etc. Each server request is sent in the form of an IP packet directed to a corresponding enterprise application executing in a server system (such as 160 or 170), with the IP packet including data identifying the desired tasks in the payload portion.

Compensation server 160 represents a server, such as a web/application server (or a cluster of such systems), executing applications such as one or more instances of the customized benefits management software. In response to receiving server requests from end user system 190A-190C, compensation server 160 performs the tasks specified in the requests and sends the result of performance of the tasks to the requesting end user system (one of 190A-190C). Compensation server 160 may use data stored internally (for example, in a non-volatile storage/hard disk within the server), external data maintained in data store 180A and/or data received from external sources (e.g., from the user) in performing such tasks.

Thus, compensation server 160 in association with data store 180A represents production system 165 which facilitates users/employees of the enterprise/customer organization to avail the various benefits customized for the enterprise. As noted above, such end user requested tasks are performed only after the benefits management software is customized and deployed on production system 165 by an administrator of the enterprise.

Testing server 170 (in association with data store 180B) represents a testing system (175) that is similar (in terms of hardware and software) to the production system (165) of compensation server 160 (and associated data store 180A). Testing system 175 facilitates administrators of the enterprise to test the various objects setup by an administrator prior to deployment in production system 165.

Administrator system 150 represents a system such as a personal computer, workstation, mobile device, tablets, etc., used by users/administrators of an enterprise to customize a benefits software program for the enterprise. In particular, administrator system 150 provides various user interfaces that facilitate an administrator to download the benefits management software from vendor system 130, deploy various instances in testing system 175, and perform desired configurations/customizations of the data/objects deployed in testing system 175. The administrator may also access the details of various benefits offered by the provider organizations (by sending appropriate requests to benefits provider systems 140A-140B and receiving corresponding responses) for customizing the benefits programs of the enterprise.

The administrator may then test the customizations (specific objects created) in testing system 175 by sending (to testing server 170) appropriate server requests from administrator system 150 or end user systems 190A-190C. After the testing and/or customization of the objects are performed to a desired satisfaction level, the tested objects are then imported into production server 165. In particular, the various objects created in testing server 170 and associated data store 180B are recreated (by importing the objects) in compensation server 160 and associated data store 180A. Once the tested objects are successfully imported into production system 165, the employees are thereafter allowed access to the tested objects/programs deployed on production system 165, and are according are enabled to avail the desired and eligible benefits (using one of end user systems 190A-190C).

In one prior approach, an administrator of the enterprise is required to manually recreate each of the tested objects in production system 165. It may be appreciated that such an approach is laborious, and may consume a large amount of resources and/or time, in particular, when the number of objects to be imported is large (e.g., more than 100). In addition, some of the tested objects may contain references/links to other tested, previously deployed or external (non benefits) objects. Accordingly, the resource/time requirement is further exacerbated, since the administrator is required to manually resolve the references (to deployed and external objects) for each of the imported objects. Thus, it may be desirable that the task of importing be simplified for the user/administrator.

Administrator system 150, extended according to the present disclosure, simplifies the importing of tested objects into benefit programs deployed on production systems (such as 165), as described below with examples.

### 3. Importing Tested Objects into Production Systems

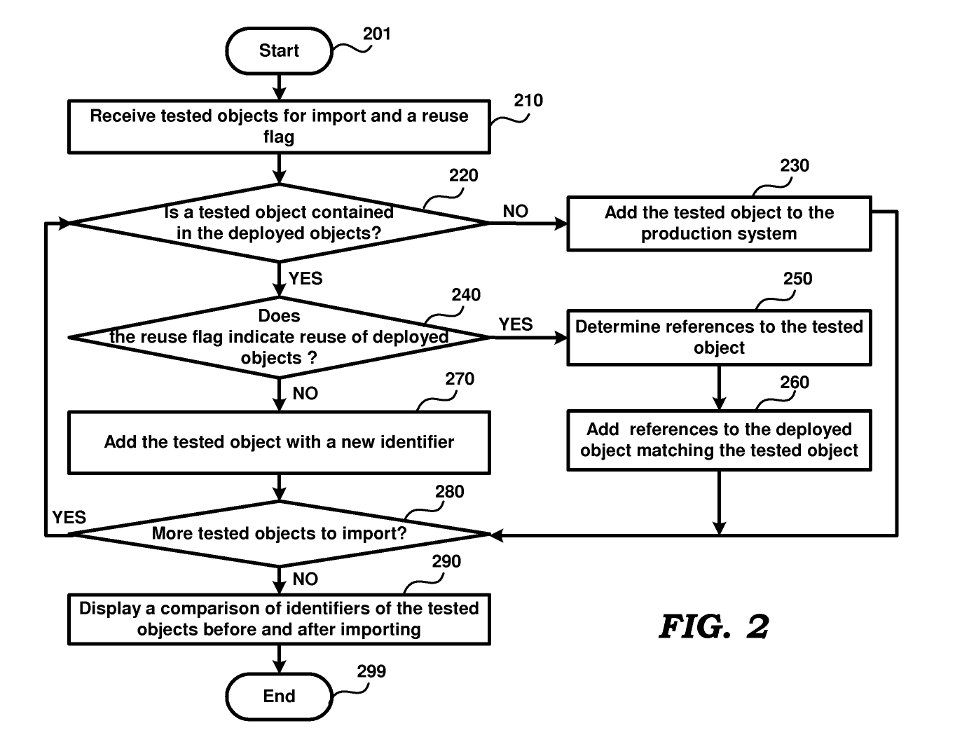

FIG. 2 is a flow chart illustrating the manner in which the importing of tested objects into benefit programs deployed on production systems is simplified in one embodiment. The flowchart is described with respect to FIG. 1, in particular, administrator system 150, for illustration purposes. However, the features can be implemented in other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. The flow chart begins in step 201, in which control immediately passes to step 210.

In step 210, administrator system 150 receives data representing the details of tested objects (including any references among the objects) sought to be imported into production system 165 and a reuse flag. The tested objects represent objects that have been tested on the testing system to a desired level of satisfaction prior to importing into the production system. The reuse flag indicates whether any of the already deployed objects in the production system can be reused or not (for example, with a first value indicating reuse and a second value indicating otherwise). The tested objects and the reuse flag may be provided by an administrator of the enterprise, using an appropriate user interfaces provided on (a display unit associated with) administrator system 150.

In step 220, administrator system 150 determines whether a received tested object is contained in the already deployed objects of the production system. In one embodiment, the determination is performed based on the identifiers (in particular, the names) of the objects. As such, the tested object is determined to be already contained in the deployed objects if the identifier of the tested object matches (has the same or similar text as) the corresponding identifier of any one of the deployed objects.

It may be readily observed that the loop of steps 220 to 280 is performed for each of the received tested objects. The tested objects at higher level in the hierarchy of received objects may be processed first in the corresponding iterations before processing the tested objects at lower levels (in the hierarchy). Control passes to step 230 if the tested object is determined to be not contained in the deployed objects (that is, the identifier of the tested object does not match the corresponding identifier of any of the deployed objects) and to steps 240 otherwise.

In step 230, upon determining that the tested object is not contained in the deployed objects, administrator system 150 adds the tested object (with the identifier specified in the received data) to production system 165. Control then passes to step 280.

In step 240, administrator system 150 determines whether the reuse flag indicates the reuse of already deployed objects (that is, whether the reuse flag is set to the first value noted above). Control passes to step 250 if the reuse flag indicates reuse of the already deployed objects (reuse flag is set to first value) and to step 270 otherwise (reuse flag is set to second value).

In step 250, upon determining that the tested object is contained in the deployed objects (in step 220) and that the reuse flag indicates reuse of the deployed objects (in step 240), administrator system 150 determines references from other tested objects to the tested object of step 220 being processed in the current iteration. In step 260, administrator system 150 adds the determined references to the deployed object matching the tested object (of step 220) to production system 165. Control then passes to step 280.

In step 270, upon determining that the tested object is contained in the deployed objects (in step 220) and that the reuse flag indicates that deployed objects are not to be reused (in step 240), administrator system 150 adds the tested object with a new identifier (instead of the identifier specified in the received data) to production system 165. Control then passes to step 280.

In step 280, administrator system 150 determines whether there are more tested objects to be imported into production system 165. The determination may be performed in any convenient way consistent with the manner in which the tested objects (data) are received. Control passes to step 220 if there are more tested objects to be imported and to step 290 otherwise. Thus, step 220 through step 280 are performed iteratively, until all the tested objects received are imported into production system 165.

In step 290, after all the received tested objects are imported, administrator system 150 sends for display a comparison of the identifiers of the tested objects before and after importing into production system 165. The comparative display of the identifiers provides to a user/administrator of the enterprise, a visual indication of whether each tested object has been imported, and if so, with the same identifier (or a different identifier) as in the received data. The flow chart ends in step 299.

Thus, by iteratively adding the tested objects and corresponding references into production system 165, the resource and/or time requirement for importing a large number of objects (and corresponding references) is reduced. Furthermore, the comparative display of step 290 facilitates users/administrators to identify any specific issues that occurred during the import.

The manner in which administrator system 150 simplifies the importing of tested objects into benefit program deployed on a production system (165) according to the steps of FIG. 2 is described below with examples.

### 4. Illustrative Example

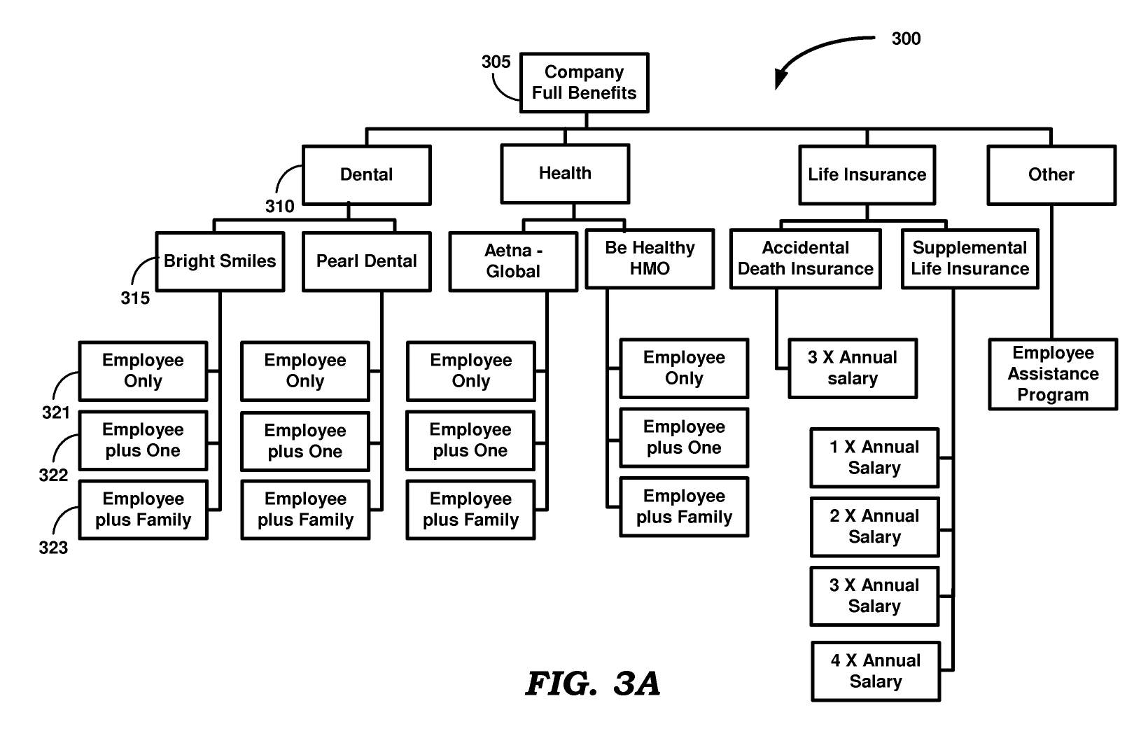

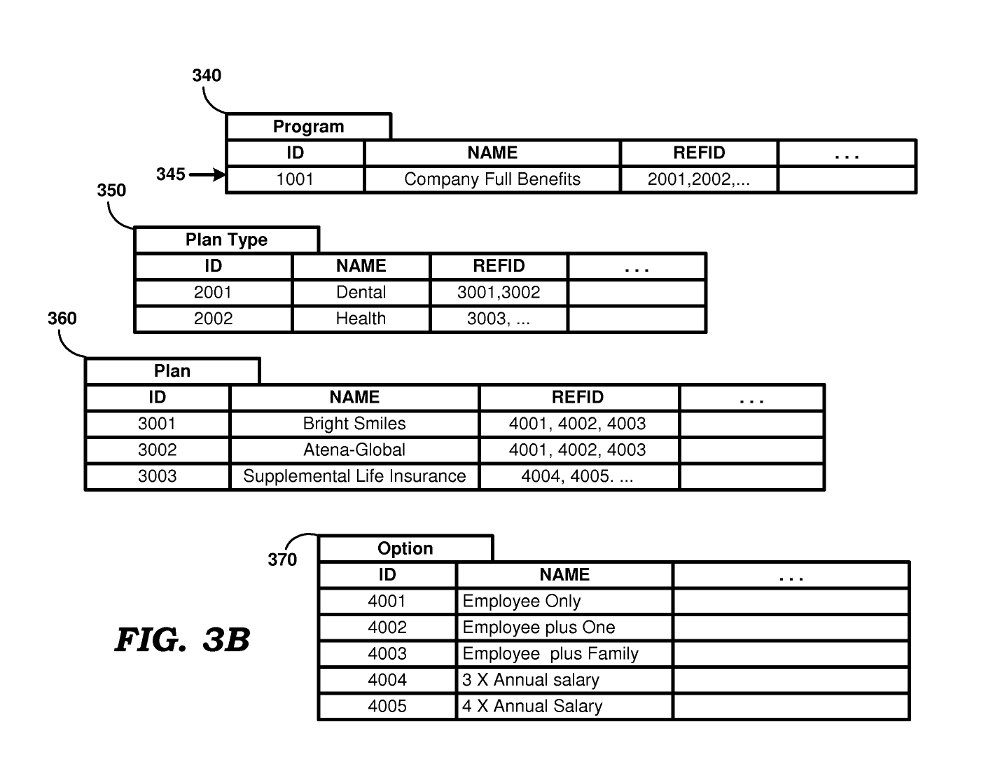

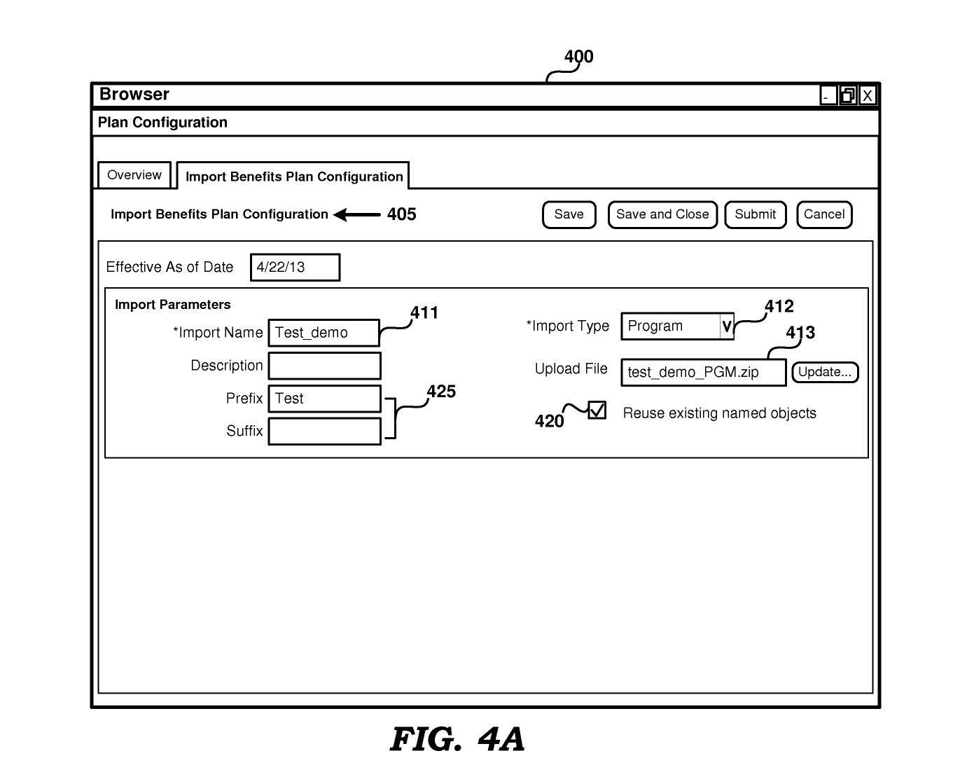

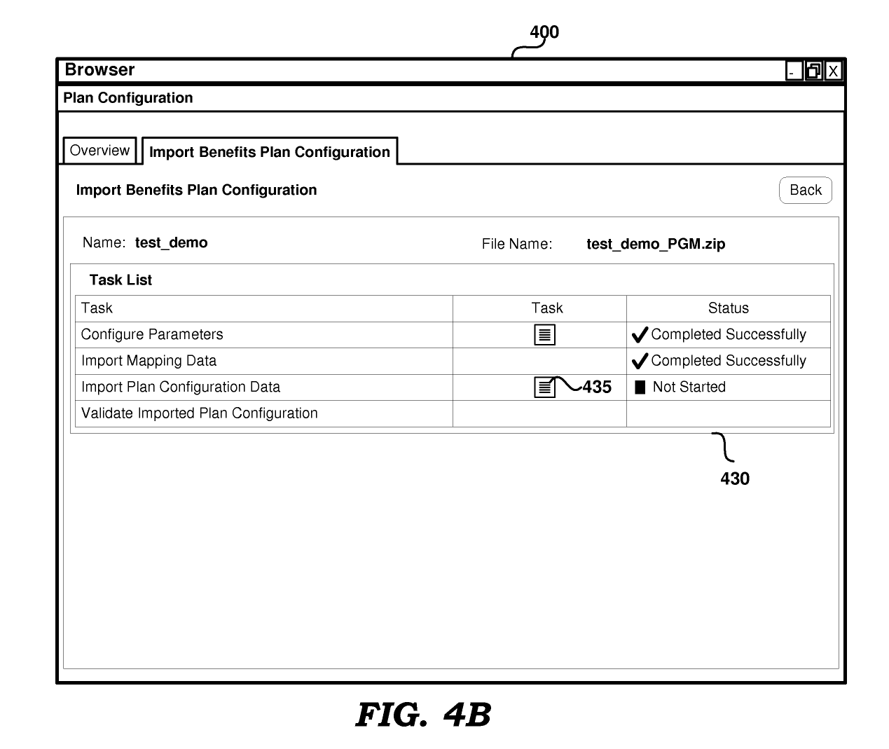

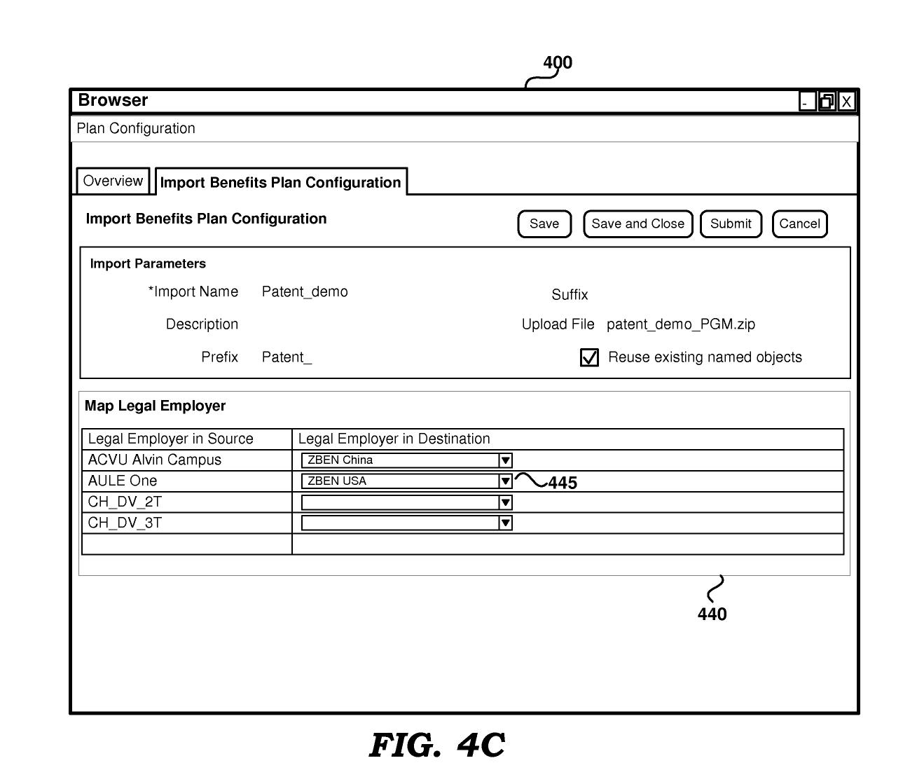

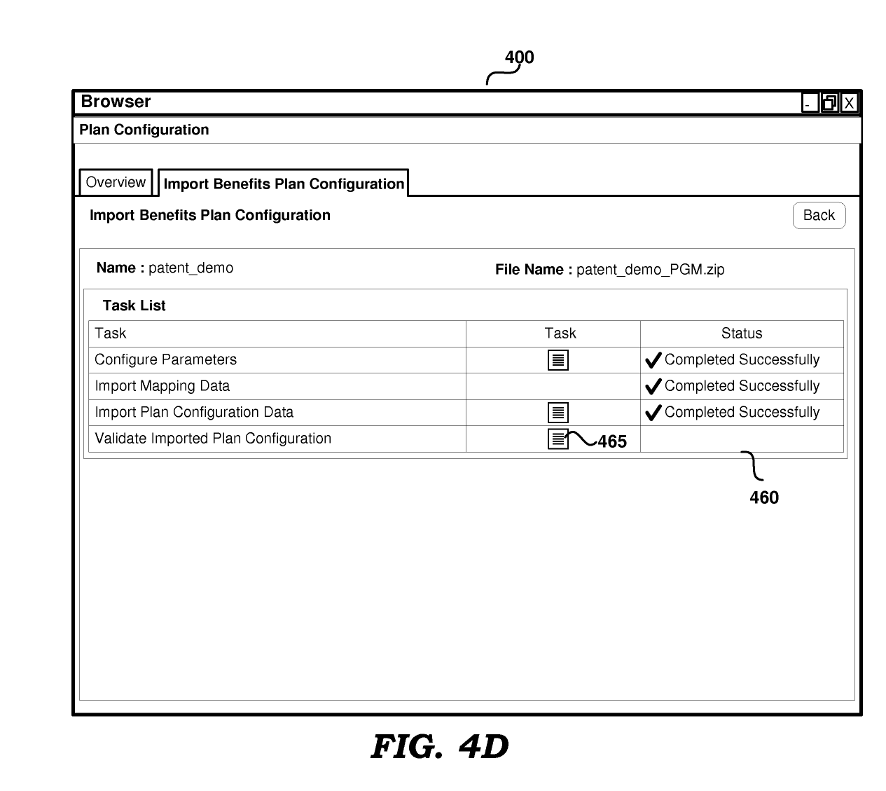

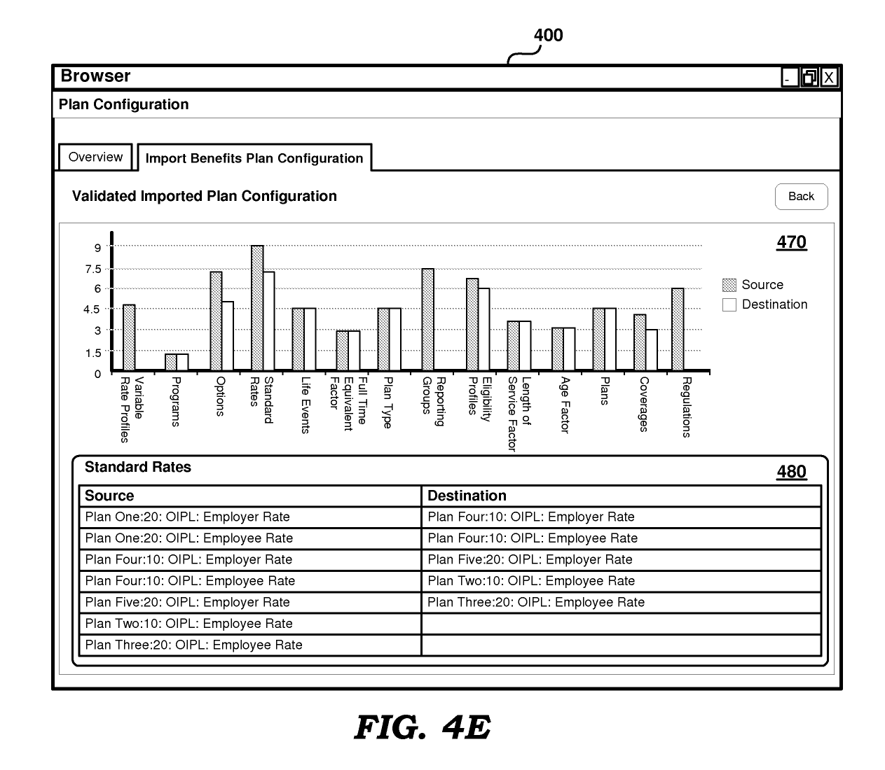

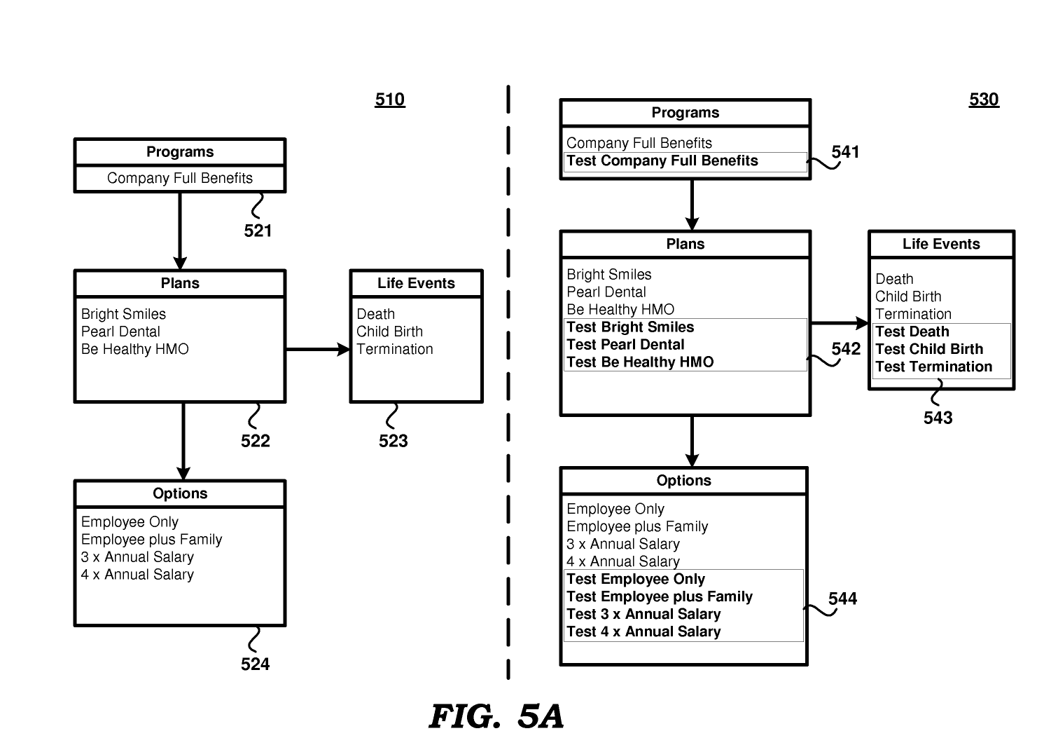

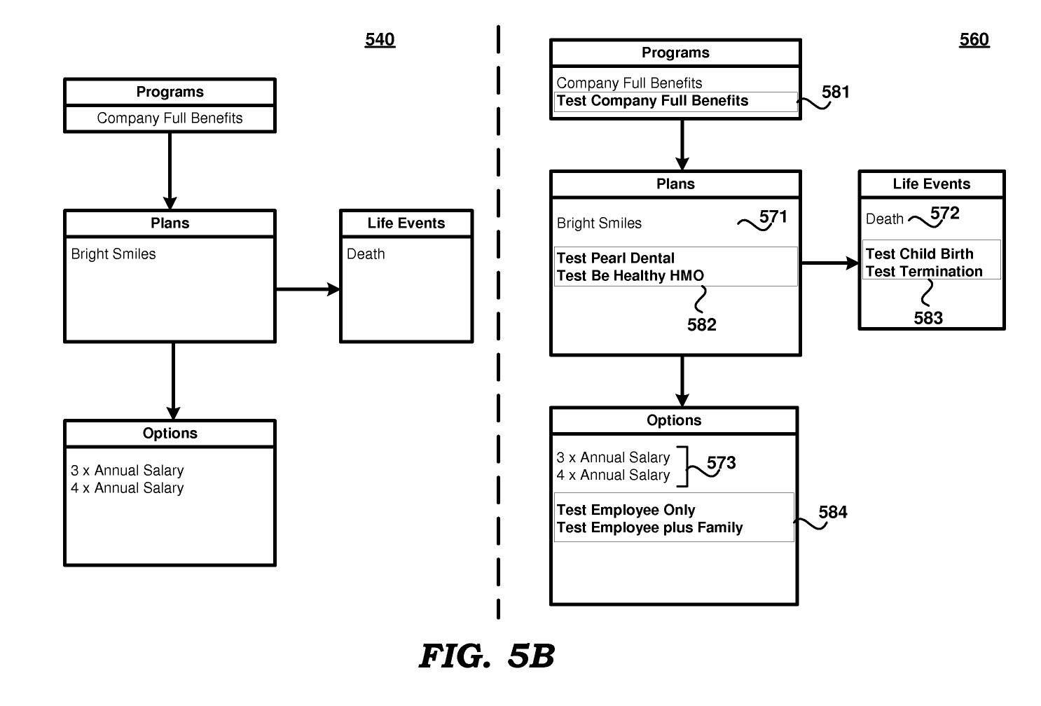

FIGS. 3A-3B, 4A-4E and 5A-5B together illustrate the manner in which assessment of setup of a benefits program is performed in one embodiment. Broadly, FIGS. 3A-3B illustrates an example benefits program already deployed in production system 165, FIGS. 4A-4E illustrates the various user interface provided to an administrator for importing desired tested objects and FIGS. 5A-5B illustrate the state of the production system before and after importing of tested objects. Each of the Figures is described in detail below.

FIG. 3A depicts a structure of a benefits program in one embodiment. In particular, the benefits program is shown organized as a hierarchy 300, with benefits program 305 named “Company Full Benefits” as the root node and other objects of different object types (such as plan type, plan, and option) shown at different levels in the hierarchy. Objects such as Dental 310, Health, Life Insurance, etc. of the object type “plan type”) are shown organized as child nodes of the root 305 (at a first level). Each plan type object (e.g. 310) in turn is shown having a corresponding set of objects such as Bright Smiles 315, Pearl Dental, etc. of the object type “plan” as child nodes (at a second level). Each plan object (e.g. 315) is in turn shown containing a corresponding set of objects such as Employee Only 321, Employee plus One 322, Employee plus Family 323, etc. of object type “option” as child nodes (at a third level). The parent-child relationships are established by corresponding references between the corresponding nodes/objects.

Only a sample set of objects, object types and levels are shown in hierarchy 300 for illustration. However, in alternative embodiments, the hierarchy may contain less or more number of objects, object types and levels, as will be apparent to one skilled in the relevant arts. The description is continued illustrating the manner in which data representing the hierarchically organized benefits program 300 is maintained (in data store 180A/180B) in one embodiment.

FIG. 3B depicts portions of data representing a benefits program (in particular program 300 shown in FIG. 3A) in one embodiment. As may be readily observed, the data is shown as being maintained in the form of multiple tables (containing rows and columns) The data may be maintained in data store 180A/180B implemented as a database server using relational database technologies (as noted above). However, alternative approaches can be employed to represent the hierarchy by using different data formats such as extensible markup language (XML) or by using different number/type of multiple normalized tables (having less/more columns, primary keys and foreign keys), as will be apparent to one skilled in the relevant arts by reading the disclosure herein.

Each of tables 340, 350, 360 and 370 represents a corresponding database table in data store 180A/180B that maintains details of benefits programs (such as hierarchy 300). Table 340 is shown as storing the details/objects of the object type (benefits) “Program” (as indicated by the first row) and containing the columns “ID”, “NAME”, and “REFID” (as indicated by the second row). The ellipsis in the next column indicates that the table may contain other columns as well, that are not shown for conciseness.

After the second row, subsequent rows in table 340 specify the corresponding details (values of the columns) for each of the objects of the object type “Program” (that is, details of the programs). Column “ID” specifies a unique number (and is a primary key) for each object stored in the corresponding row, while column “NAME” specifies a unique identifier for each object. Column “REFID” indicates the numbers of the specific objects that are at an immediate lower level in the hierarchy (for example, 300) and that are referenced by the object in the row.

Thus, row 345 indicates that an object of (benefits) program type has the unique number 1001 (column “ID”), is identified by the unique identifier “Company Full Benefits”, and has references to the objects having the number “2001”, “2002”, etc. of the object type “plan type” (and which are accordingly shown as corresponding rows in table 350 for object type “plan type”). It should be noted that only a sample number of objects are shown in each table, and accordingly the REFID column is shown indicating only some of the numbers of the referenced objects. Similarly, tables 350, 360 and 370 are shown maintaining the details of the various objects of object types “Plan Type”, “Plan” and “Option” respectively.

Thus, FIGS. 3A and 3B together illustrate a hierarchically organized benefits program (300) that may be provided to employees of a customer organization, such as the organization shown in FIG. 1. The description is continued assuming that the various objects of benefit program 300 are already deployed in production system 165 (with the data of FIG. 3B maintained in data store 180A). The manner in which an administrator may be facilitated to import desired tested objects (similar to the objects shown in FIGS. 3A and 3B) into benefits program 300 is described below with examples.

### 5. Example User Interfaces

FIG. 4A-4D together illustrates the manner in which an administrator is facilitated to import desired tested objects into benefit program deployed on a production system in one embodiment. Display area 400 depicts a portion of a user interface provided on a display unit (not shown in FIG. 1) associated with administrator system 150. In one embodiment, display area 400 corresponds to a browser displaying respective web pages provided by administrator system 150. The web pages are provided in response to an administrator of the enterprise sending appropriate requests, for example, including the uniform resource locators (URLs) of the web pages, to administrator system 150.

Referring to FIG. 4A, display area 405 indicates that the user interface of display area 400 is for importing a benefits plan configuration into a production system (such as 165). An administrator may accordingly specify a name (“Test_demo”) for the import in text field 411, a description (shown as empty) for the import, the root object type (“Program”) sought to be imported in select field 412, and the name of the file (“test_demo_PGM.zip”) containing data representing the tested objects to be imported in upload file field 413. The file may be generated by exporting the desired tested objects from testing system 175 in a known way.

The administrator may also specify whether already deployed objects (that is, “existing named objects”) in production system 165 are to be reused by selecting/checking checkbox 420. The selection/checking (as shown in FIG. 4A) of checkbox 420 indicates that the deployed objects are to be reused, with a non-selection/non-checking indicating no reuse of the deployed objects. Thus, checkbox 420 operates as a reuse flag for the tested objects sought to be imported. In addition, the administrator may also specify in prefix/suffix text field 425, corresponding texts to be used for generating a new identifier when reuse flag/checkbox 4520 is not selected. Administrator system 150 may accordingly generate a new identifier by concatenating the text specified in the prefix text field (of 425), the original identifier of the object as specified in the received data (file specified in field 413) and the text specified in the suffix text field (of 425).

After specifying the desired tested objects to be imported and the value of the reuse flag, and administrator may select/click on the “Submit” button to initiate the import. In response, administrator system 150 performs the steps of FIG. 2 to cause importing of the tested objects (specified in the file) into production system 165.

Referring to FIG. 4B, display area 430 indicates the status of performing the various tasks of importing the tested objects into production system 165. In particular, display area 430 indicates that the tasks of configuring the parameters for import (using the interface of FIG. 4A) and of receiving/uploading the tested objects are completed successfully. However, the actual importing of the tested objects is indicated to have not started.

Such a scenario may occur when the tested objects sought to be imported have references to external (non benefits) objects such as jobs, positions, grades, organizations, locations, addresses, payroll, performance ratings, etc. that are maintained in other systems (by other applications) such as human resource, payroll, and talent management systems. Though administrator system 150 tries to resolve such external objects based on matching of identifiers (similar to benefits objects), there may be some external objects that cannot be resolved based on such matching. In one embodiment, administrator system 150 facilitates the administrator to manually specify the corresponding objects to be used for such external objects. Accordingly, in response to an administrator selecting/clicking icon 435, administrator system 150 provides display area 400 of FIG. 4C.

Referring to FIG. 4C, display area 440 enables the administrator to specify/map for each unresolved external object in source/received data, a corresponding object in destination system (such as human resource, payroll, etc.) to be used. For example, row 445 indicates that the administrator has specified that the external object “AULE One” specified in the tested objects sought to be imported is to be mapped to the object named “ZBEN USA”. In response to the administrator selecting/clicking the “Submit” button shown there, administrator system 150 uses the administrator provided mappings for importing the tested objects. In particular, a reference from a tested object to an external object (such as “AULE One”) is imported into production system 165 as a corresponding reference from the imported tested object to the user specified object (“ZBEN USA”).

Administrator system 150 also performs the steps of the flowchart of FIG. 2 iteratively until all the tested objects contained in the file named “test_demo_PGM.zip” (indicated in field 413) are imported into production system 165. It should be noted that such importing is performed based on the value of the reuse flag/checkbox 420 and the values specified in prefix/suffix text field 425.

Referring to FIG. 4D, display area 460 is similar to display area 430 of FIG. 4B and shown the updated status of performing the various tasks of importing the tested objects into production system 165. In particular, display area 460 indicates that the actual task of importing of the tested objects into benefit programs deployed on production system 165 is also completed successfully. A user/administrator may thereafter select/click icon 465 to validate the importing of the tested objects, in particular to check whether any issues occurred during the import.

### 6. Validating Import of Tested Objects

FIG. 4E illustrates the manner in which an administrator is facilitated to validate the import of tested objected into a production system in one embodiment. According to an aspect of the present disclosure, administrator system 150 displays for each object type, a corresponding first count of tested objects in the received data and a corresponding second count of the tested objects that have been added to the production system (165).

Thus, display area 470 provides a comparison of the first and second counts of different object types in the form of a bar graph. In particular, the object types are shown along the horizontal axis, while the counts are shown along the Y axis. Each object type is shown in the form of a pair of adjoining bars, a gray bar indicating the first count and a white bar indicating the second count for the object type. It may be observed that the same height for both the bars in the pair (such as for the object types “Life Events”, “Plan Type”, etc.) indicates that all the tested objects are added into production system 165. On the other hand, the bars having different heights (such as for the object types “Standard Rates”, “Coverages”, etc.) indicates that only some of the received tested objects are added to production system 165 and that some of the deployed objects corresponding to the tested objects are reused.

According to another aspect of the present disclosure, administrator system 150 displays, for each object type, a first list of identifiers of tested objects of the object type contained in the received data, and a second list of identifiers of the tested objects of the same object type which have been added to production system 165. The second list includes the original identifier or the new identifier for each object added to production system 165, but does not include the identifier of the reused deployed objects.

Thus, display area 480 is showing displaying a first list of identifiers in the column labeled “Source” and a second list of identifiers in the column labeled “Destination” for the object type “Standard Rates”. Display area 480 may be displayed in response to the administrator selecting/clicking on the object type “Standard Rates” in the bar graph shown in display area 470. It may be observed that the second list does not include the identifiers “Plan One:20: OIPL: Employer Rate” and “Plan One:20: OIPL: Employee Rate” indicating that these tested objects are not added to production system 165 and instead already deployed objects corresponding to these tested objects are reused.

It may be appreciated that the first and second list of identifiers may be used by an administrator to identify the state of the production system before and after the import is performed. For example, the presence of the original identifier of a tested object in both the first and second lists (i.e., both columns) indicates that the first tested object is as such added to the production system. The presence of the original identifier of a tested object in the first list and the presence of a new identifier (formed by concatenation of the prefix, the original identifier and the suffix) in the second list indicates that the tested object was added with the new identifier to the production system (in response to the first tested object having a matching deployed object, but the reuse flag indicating no reuse of the deployed objects). The presence of the original identifier of the tested object in only the first list (and not in the second list) indicates that a matching deployed object was reused instead of adding the tested object to the production system.

Thus, the user interfaces of FIGS. 4A-4E together facilitates administrators of an enterprise to import tested objects into benefit programs deployed on production system 165. Furthermore, the administrator is enabled to identify the specific issues that occurred during the import using the interface of FIG. 4E.

FIGS. 5A-5B illustrates the state of a production system (165) before and after importing of tested objects into benefits programs deployed on the production system in one embodiment. In particular, 510 of FIG. 5A depict various objects of benefits program 300 that are already deployed in production system 165 before importing of tested objects. Each of boxes 521-524 represents a corresponding table (similar to tables 340, 350, etc.) shown in FIG. 3B. The state of the production system after importing the objects in the same benefit program 300 area with the reuse flag set to no reuse of already deployed objects is shown in 530. It may be observed that portions 541-544 indicate that all the benefit objects are added to the production system with the test “Test” prefixed (as provided by the administrator in field 425).

Referring to FIG. 5B, 540 there depicts the state of production system 165 before importing of tested objects. The state of the production system 165 after importing the objects in the same benefit program 300 imported with the reuse flag set to reuse of already deployed objects is shown in 530. It may be observed that already deployed objects in portions 571-573 are shown as being reused, while the objects in portions 581-584 are indicated to be added to the production system with the test “Test” prefixed.

It should be appreciated that the features described above can be implemented in various embodiments as a desired combination of one or more of hardware, executable modules, and firmware. The description is continued with respect to an embodiment in which various features are operative when executable modules are executed.

### 7. Digital Processing System

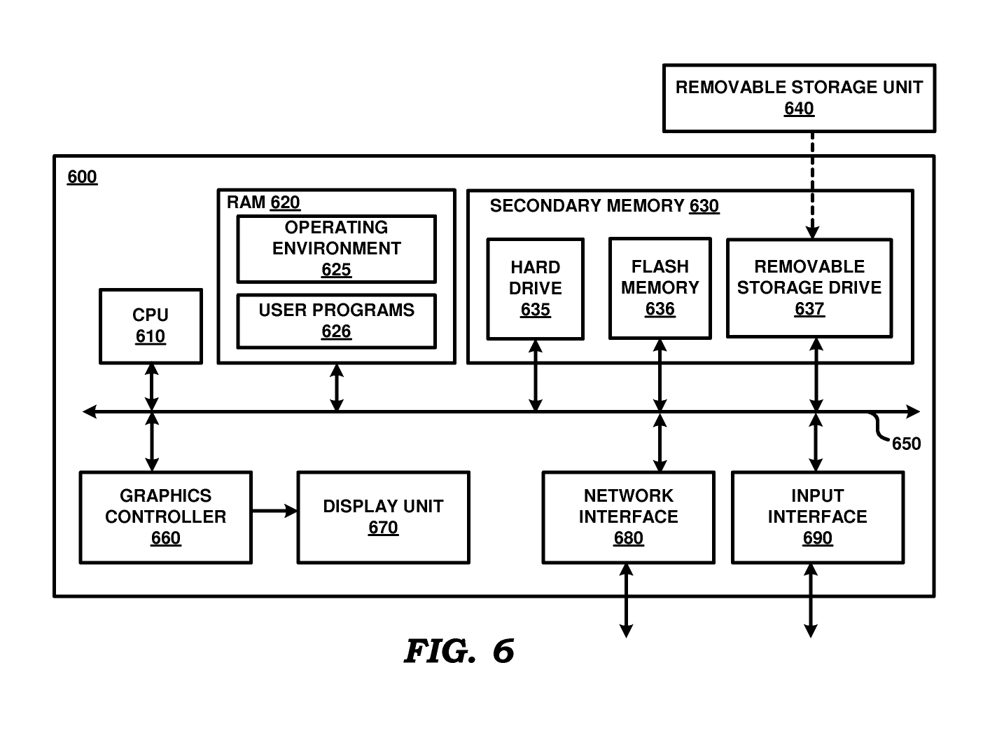

FIG. 6 is a block diagram illustrating the details of digital processing system 600 in which various aspects of the present disclosure are operative by execution of appropriate executable modules. Digital processing system 600 may correspond to administrator system 150.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting operating environment 625 and/or other user programs 626 (such as the instances of benefits management software in an enterprise, etc.). In addition to operating environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images defined by the display signals. Each of the displays shown in FIGS. 4A-4E corresponds to an image screen at corresponding time duration on the display screen. Input interface 690 may correspond to a keyboard and a pointing device (e.g., touch-pad, mouse) and may be used to provide inputs (such as those provided by the administrators of the enterprise using the interfaces of FIGS. 4A-4E as described above). Network interface 680 provides connectivity to a network (e.g., using Internet Protocol), and may be used to communicate with other systems connected to the network (such as compensation server 160, testing server 170, etc.).

Secondary memory 630 may contain hard drive 635, flash memory 636, and removable storage drive 637. Secondary memory 630 may store the data (for example, portions of the data shown in FIG. 3A-3B, the data entered by an administrator in the interfaces of FIGS. 4A-4E, etc.) and software instructions (for implementing the steps of FIG. 2), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Secondary memory 630 may contain hard drive 635, flash memory 636, and removable storage drive 637. Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as secondary memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 8. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating importing of tested objects into benefit programs deployed on a production system, said method comprising:
receiving a first data and a second data, said first data representing a plurality of tested objects sought to be imported to said production system, said second data indicating whether or not to reuse any of a plurality of deployed objects already deployed in said production system;
determining whether a first tested object of said plurality of tested objects is contained in said plurality of deployed objects;
if said first tested object is determined to be contained in said plurality of deployed objects and if said second data indicates the reuse of said plurality of deployed objects:
determining a second tested object of said plurality of tested objects having a reference to said first tested object by examining said first data; and
adding said reference from said second tested object to a first deployed object of said plurality of deployed objects corresponding to said first tested object, wherein said first deployed object is reused instead of adding said first tested object to said production system;
if said first tested object is determined to be contained in said plurality of deployed objects and if said second data indicates not to reuse said plurality of deployed objects:
adding said first tested object with a new identifier to said production system, wherein said new identifier is different from a first identifier identifying said first tested object in said first data.

2. The method of claim 1, if said first tested object is determined as not being contained in said plurality of deployed objects:
adding said first tested object with said first identifier to said production system.

3. The method of claim 2, if said first tested object is determined to be contained in said plurality of deployed objects and if said second data indicates not to reuse said plurality of deployed objects, said method further comprising:
determining a third tested object of said plurality of tested objects having a second reference to said first tested object by examining said first data; and
adding said second reference from said third tested object to said first tested object with said new identifier to said production system.

4. The method of claim 1, wherein each of said plurality of deployed objects and each of said plurality of tested objects is one of a plurality of object types, said first tested object being of a first object type of said plurality of object types, wherein said determining comprises:
comparing said first identifier of said first tested object with the identifiers of only the deployed objects of said first object type; and
identifying an identifier of said first deployed object as matching said first identifier,
wherein said determining determines that said first tested object is contained in said plurality of deployed objects if said identifying identifies said first deployed object in said first set of deployed objects.

5. The method of claim 4, wherein said plurality of deployed objects include a first hierarchy of deployed objects and a second hierarchy of deployed objects,
wherein said comparing compares said first identifier with objects of said first object type contained in said first hierarchy of deployed objects and also with objects of said first object type contained in said second hierarchy of deployed objects.

6. The method of claim 5, wherein said plurality of object types includes benefit programs, benefit plan types, benefit plans, and benefit options.

7. The method of claim 4, wherein said first tested object is of a benefit plan object type such that said first tested object represents a tested benefit plan and said second tested object is of a benefit program object type such that said second tested object represents a tested benefit program,
wherein said second tested object is not contained in said plurality of deployed objects prior to receiving of said first data,
wherein said first data and said second data are received to add said tested benefit program referencing said tested benefit plan to said production system.

8. The method of claim 4, further comprising:
displaying, for each of said plurality of object types, a corresponding first count of tested objects contained in said plurality of tested objects, and a corresponding second count of tested objects that have been added to said production system, wherein the reused said first deployed object is not included in said second count.

9. The method of claim 8, further comprising:
displaying, for each object type, a first list of identifiers of tested objects of said object type contained in said plurality of tested objects, and a second list of identifiers of the tested objects of said object type which has been added to said production system,
wherein said second list includes said first identifier or said new identifier for each object added to said production system, and does not include the identifier of the reused said first deployed object.

10. The method of claim 9, wherein the presence of said first identifier in both of said first list and said second list indicates that said first tested object is added to said production system,
wherein the presence of said first identifier in said first list and the presence of said new identifier in said second list indicates that said first tested object was added with said new identifier to said production system,
wherein the presence of said first identifier in only said first list and not in said second list indicates that said first deployed object was reused instead of adding said first tested object to said production system.

11. A non-transitory machine readable medium storing one or more sequences of instructions for enabling a system to facilitate importing of tested objects into benefit programs deployed on a production system, wherein execution of said one or more instructions by one or more processors contained in said system enables said system to perform the actions of:
receiving a first data and a second data, said first data representing a plurality of tested objects sought to be imported to said production system, said second data indicating whether or not to reuse any of a plurality of deployed objects already deployed in said production system;
determining whether a first tested object of said plurality of tested objects is contained in said plurality of deployed objects;
if said first tested object is determined to be contained in said plurality of deployed objects and if said second data indicates the reuse of said plurality of deployed objects:
determining a second tested object of said plurality of tested objects having a reference to said first tested object by examining said first data; and
adding said reference from said second tested object to a first deployed object of said plurality of deployed objects corresponding to said first tested object, wherein said first deployed object is reused instead of adding said first tested object to said production system;
if said first tested object is determined to be contained in said plurality of deployed objects and if said second data indicates not to reuse said plurality of deployed objects:
adding said first tested object with a new identifier to said production system, wherein said new identifier is different from a first identifier identifying said first tested object in said first data.

12. The machine readable medium of claim 11, containing one or more instructions for:
if said first tested object is determined as not being contained in said plurality of deployed objects:
adding said first tested object with said first identifier to said production system.

13. The machine readable medium of claim 11, wherein each of said plurality of deployed objects and each of said plurality of tested objects is one of a plurality of object types, said first tested object being of a first object type of said plurality of object types, wherein said determining comprises one or more instructions for:
comparing said first identifier of said first tested object with the identifiers of only the deployed objects of said first object type; and
identifying an identifier of said first deployed object as matching said first identifier,
wherein said determining determines that said first tested object is contained in said plurality of deployed objects if said identifying identifies said first deployed object in said first set of deployed objects.

14. The machine readable medium of claim 13, further comprising one or more instructions for:
displaying, for each of said plurality of object types, a corresponding first count of tested objects contained in said plurality of tested objects, and a corresponding second count of tested objects that have been added to said production system, wherein the reused said first deployed object is not included in said second count.

15. The machine readable medium of claim 14, further comprising one or more instructions for:
displaying, for each object type, a first list of identifiers of tested objects of said object type contained in said plurality of tested objects, and a second list of identifiers of the tested objects of said object type which has been added to said production system,
wherein said second list includes said first identifier or said new identifier for each object added to said production system, and does not include the identifier of the reused said first deployed object.

16. A computing system comprising:
a production system deployed with benefit programs in the form of a plurality of deployed objects;
an administrator system to facilitate importing tested objects into said benefit programs deployed on said production system, said administrator system operable to:
receive a first data and a second data, said first data representing a plurality of tested objects sought to be imported to said production system, said second data indicating whether or not to reuse any of said plurality of deployed objects;
determine whether a first tested object of said plurality of tested objects is contained in said plurality of deployed objects;
if said first tested object is determined to be contained in said plurality of deployed objects and if said second data indicates the reuse of said plurality of deployed objects:
determine a second tested object of said plurality of tested objects having a reference to said first tested object by examining said first data; and
add said reference from said second tested object to a first deployed object of said plurality of deployed objects corresponding to said first tested object, wherein said first deployed object is reused instead of adding said first tested object to said production system;
if said first tested object is determined to be contained in said plurality of deployed objects and if said second data indicates not to reuse said plurality of deployed objects:
add said first tested object with a new identifier to said production system, wherein said new identifier is different from a first identifier identifying said first tested object in said first data.

17. The computing system of claim 16, wherein said administrator system is further operable to:
if said first tested object is determined as not being contained in said plurality of deployed objects:
add said first tested object with said first identifier to said production system.

18. The computing system of claim 16, wherein each of said plurality of deployed objects and each of said plurality of tested objects is one of a plurality of object types, said first tested object being of a first object type of said plurality of object types, wherein to perform said determination, said administrator system is operable to:
compare said first identifier of said first tested object with the identifiers of only the deployed objects of said first object type; and
identify an identifier of said first deployed object as matching said first identifier,
wherein said administrator system determines that said first tested object is contained in said plurality of deployed objects if said administrator system identifies said first deployed object in said first set of deployed objects.

19. The computing system of claim 18, said administrator system further operable to:
display, for each of said plurality of object types, a corresponding first count of tested objects contained in said plurality of tested objects, and a corresponding second count of tested objects that have been added to said production system, wherein the reused said first deployed object is not included in said second count.

20. The computing system of claim 19, said administrator system further operable to:
display, for each object type, a first list of identifiers of tested objects of said object type contained in said plurality of tested objects, and a second list of identifiers of the tested objects of said object type which has been added to said production system,
wherein said second list includes said first identifier or said new identifier for each object added to said production system, and does not include the identifier of the reused said first deployed object.
